(19) United States
(12) Patent Application Publication
(10) Pub. No.: US 2004/0244557 A1
(43) Pub. Date: Dec. 9, 2004

(54) Sawmill

(76) Inventor: Carl James Peterson, Rotorua (NZ)

Correspondence Address: Dr O M (Sam) Zaghmout, Bio IPS, 8509 Kernon Street, Lorton, VA, 22079, US

(21) Appl. No.: 10/493,303

(22) PCT Filed: Oct. 25, 2002
(86) PCT No.: PCT/NZ02/00223

(30) Foreign Application Priority Data
Oct. 31, 2001 (NZ) 515199

(51) Int. Cl. B26D 1/12

(52) U.S. Cl. 83/663

(57) ABSTRACT

According to the invention there is provided a sawmill, the sawmill having first and second support frame 1 and 2, first and second rails 4 and 4, a first carriage 5, a second carriage 6, height adjustment drive means, and connection means; the sawmill being formed such that when it is in use it can be arranged with the first and second support frames 1 and 2 holding the first and second rails 3 and 4 in substantially horizontal elevated parallel relationship, the first carriage 5 being associated with the rails 3 and 4 and being capable of carrying a saw 7 longitudinally along such rails, the second carriage 6 being capable of moving the saw cross-ways with respect to the rails, the drive means being associated with the first support frame and the connection means connecting the drive means with the first rail and the second end frame; the sawmill being formed such that when it is in use the drive means can move the connection means to impart a lifting force at each of two opposite end parts of the first rail 1 to cause the first rail to raise while the first rail maintains a substantially horizontal orientation.

### FIELD OF INVENTION

This invention relates to a saw mill.

### BACKGROUND

In the context of sawmilling it is known to use modular portable mills consisting of a pair of rails elevated and held horizontally in spaced parallel relationship by a pair of end frames. In such known embodiments a saw carriage can roll along the rails in a length-ways direction, and a sub-carriage mounted on the saw carriage can roll on the saw carriage in a cross-ways direction with respect to the rails. This enables a saw blade mounted on the sub-carriage to be moved to a desired position relative to the rails to enable milling of a log situated beneath the rails. One such prior art sawmill is described in Australian patent specification No. 27314/88 in the name of Carl James Peterson.

Those skilled in the art will appreciate that the height of the rails must be adjusted during the sawmilling process in order to bring a saw blade into contact with the log as the log is progressively milled to a diminishing size. This may be achieved by lowering end parts of the rails at one of the end frames, and then lowering opposite end parts of the rails by the same amount at the opposite end frame. This two step process means that for a time the rails are in an inclined position. A disadvantage of this is that while the rails are in an inclined position the saw carriage may undesirably roll downwards along the rails under the force of gravity, potentially presenting an inconvenience or a safety hazard. A further disadvantage with some known sawmills is that to raise or lower the rails an operator must use a first windlass at one of the end frames, and then another windlass at the opposite end frame. The operator must thus walk the length of the rails to adjust their height.

It is an object of at least one form of the present invention to go at least some way towards addressing at least one of the above disadvantages, or to at least provide the public with a useful choice.

### GENERAL DESCRIPTION

According to one aspect of the invention there is provided a sawmill, the sawmill having first and second support frame, first and second rails, a first carriage, a second carriage, height adjustment drive means, and connection means;

the sawmill being formed such that when it is in use it can be arranged with the first and second support frames holding the first and second rails in substantially horizontal elevated parallel relationship, the first carriage being associated with the rails and being capable of carrying a saw longitudinally along such rails, the second carriage being capable of moving the saw cross-ways with respect to the rails, the drive means being associated with the first support frame and the connection means connecting the drive means with the first rail and the second end frame;

the sawmill being formed such that when it is in use the drive means can move the connection means to impart a lifting force at each of two opposite end parts of the first rail to cause the first rail to raise while the first rail maintains a substantially horizontal orientation.

The connection means may involve filamentary material, a threaded rod or rods, a rotatable shaft or shafts, or a right angle gear box or gear boxes, or suitable combinations of these.

Preferably the drive means involves a winch mechanism mounted at one side part of the first support frame.

Preferably the connection means incorporates filamentary material extending between the drive means and the first rail, incorporates shaft means extending between the support frames, incorporates force transfer means at the second end frame, and incorporates a further filamentary material extending from the force transfer means to the first rail.

Preferably the filamentary material is in each case a length or lengths of chain, cord, or similar.

The shaft means may or may not be hollow.

The shaft means may be capable of spinning to transfer a degree of force to one of the said two opposite end parts of the first rail which is adjacent the second frame.

Optionally the shaft means may not be capable of spinning but may house filamentary material which can move to transfer a degree of force to one of the said two opposite end parts of the first rail which is adjacent the second frame.

Preferably the support frames are associated with diagonal ground engaging telescoping struts to enhance the structural integrity of the sawmill when it is in use.

Preferably the drive means involves a second winch mechanism mounted at a second side part of the first support frame at a position opposite the first mentioned side part of the first support frame, a further length of filamentary material extending between the second drive means and the second rail, a second shaft means extending between the support frames, a second force transfer means at the second end frame, and a further length of filamentary material, or other suitable means, extending from the second force transfer means to the second rail, the second winch mechanism being capable of imparting a lifting force at each of two opposite end parts of the second rail to cause the second rail to raise while the second rail maintains a substantially horizontal orientation.

Preferably the first and second rails are mounted on sleeve containing brackets, the sleeve containing brackets being capable of moving in a substantially vertical direction along parts of the support frames to move the rails correspondingly. In at least some embodiments of the invention the sleeve containing brackets may be taken to be part of the support frames with which they are associated. The sleeve containing brackets may be formed such that they can slide along the rails to enable them to be positioned appropriately with respect to the rails during assembly of the sawmill.

### BRIEF DESCRIPTION OF THE DRAWINGS

Some preferred aspects and embodiments of the invention will now be described by way of example, and/or with reference to the accompanying drawings, of which:

FIG. 1 is a three dimensional view of a portable sawmill.

FIG. 2 is a side-on view of the sawmill,

FIG. 3 shows detail of some height adjustment parts of the sawmill, and

FIG. 4 shows further detail of additional parts of the sawmill.

### DETAILED DESCRIPTION

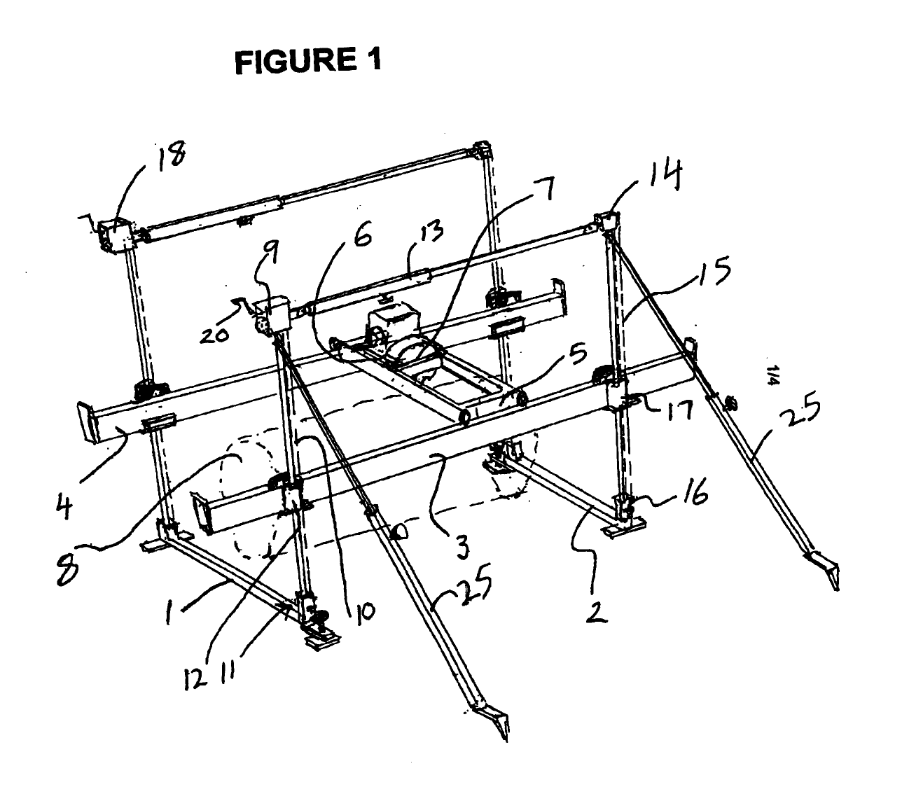

With reference to FIG. 1, the sawmill has a first support frame 1, a second support frame 2, a first rail 3, and a second rail 4. As shown, the first and second rails 3 and 4 are held in elevated spaced parallel relationship by the support frames 1 and 2. A saw carriage 5 (eg a first carriage) is mounted between the rails 3 and 4, and can roll along these in a longitudinal direction with respect to the rails. A sub-carriage 6 (eg a second carriage) is mounted on the saw carriage 5, and can move along the saw carriage 5 in a direction which is “cross ways” with respect to the rails 3 and 4. Mounted on the sub-carriage 6 is a motor driven circular saw 7. The blade of the saw 7 is capable of swinging between a horizontal orientation and a vertical orientation to enable vertical and horizontal cuts to be made in a log 8 as desired. As an alternative to a swinging blade arrangement there may be a plurality of fixed or moveable blades mounted on the sub-carriage.

As will be appreciated by those skilled in the art, the saw carriage 5 and the sub-carriage 6 can be moved with respect to the rails 3 and 4 to bring the saw 7 into the desired position for milling the log into pieces of timber—eg into flitches. A first length of filamentary material 10, eg chain or cord, extends in a loop from the first winch 9, to a bush 11 at the base of the first support frame, from the bush 11 upwards to a sleeve containing bracket 12, and from the bracket 12 upwards to the first winch 9. A telescoping shaft 13 is attached to the winch 9 and extends substantially horizontally and parallel to the rails 3 and 4 to a force transfer means, eg a sprocket arrangement 14, at or adjacent the second support frame 2. A second length of filamentary material 15 extends in a loop from the sprocket arrangement 14 to a bush 16 at the base of the second support frame 2, then upwards to a second sleeve containing bracket 17, and upwards from the second sleeve containing bracket 17 to the sprocket arrangement 14.

When an operator turns the handle of the first winch 9 in an appropriate direction the first length of filamentary material 10 moves, the telescoping shaft 13 rotates, the sprocket arrangement 14 rotates, and the second length of filamentary material 15 moves also. The arrangement is such that force from the first winch 9 pulls on the sleeve containing brackets 12 and 17 to move them upwards. The first rail 3 is mounted on the sleeve containing brackets 12 and 17 and so moves in a corresponding fashion. The first support frame 1 also has a second winch 18 opposite the first winch 9. The second winch 18 is associated with the second rail 4 in the same way that the first winch 9 is associated with the first rail 3. The second winch 18 is thus associated with further bushes, further lengths of filamentary material, a further shaft, a further sprocket arrangement, and further sleeve containing brackets. An operator can thus appropriately rotate the handle of the second winch 18 to raise the second rail 4. The rails 3 and 4 can of-course be lowered by rotating the handles of the winches 9 and 18 in an opposite direction to that required for raising them. It will be appreciated that two operators can each work on a different one of the winches 9 and 18 so that the rails 3 and 4 can be raised or lowered in unison.

In some embodiments of the invention the winches 9 and 18 may be arranged such that a positive lifting force, and a subsequent positive lowering force, can be applied to the rails 3 and 4.

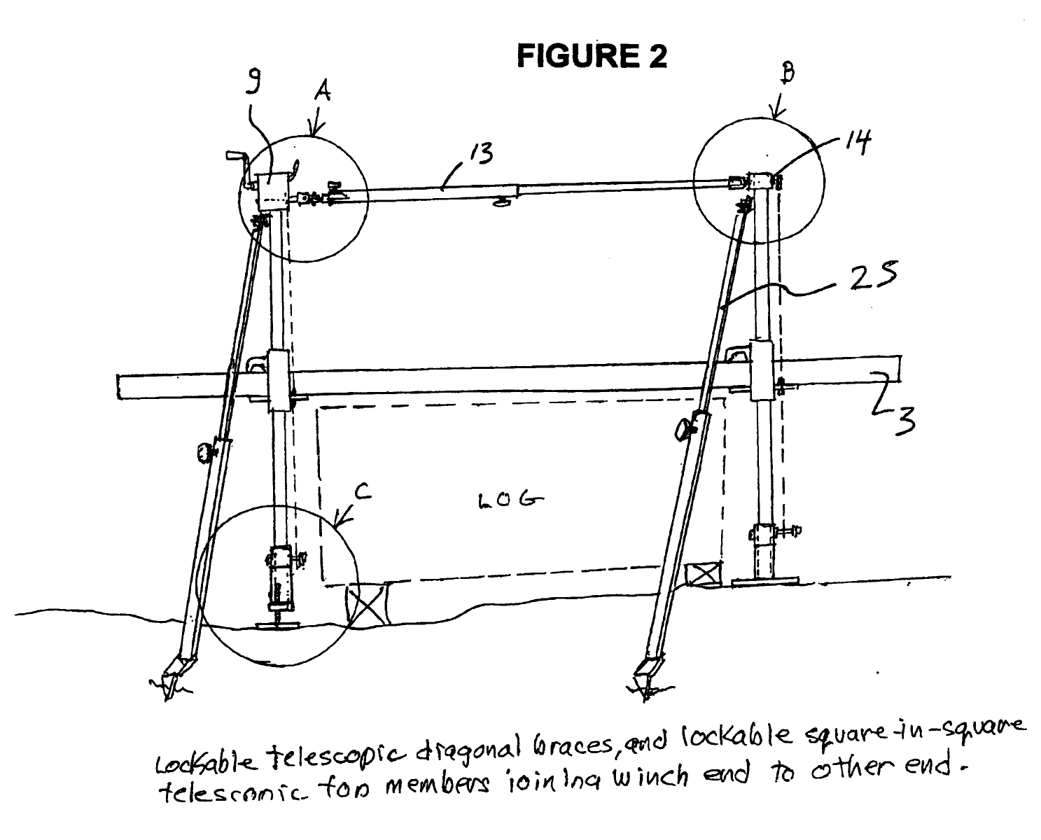

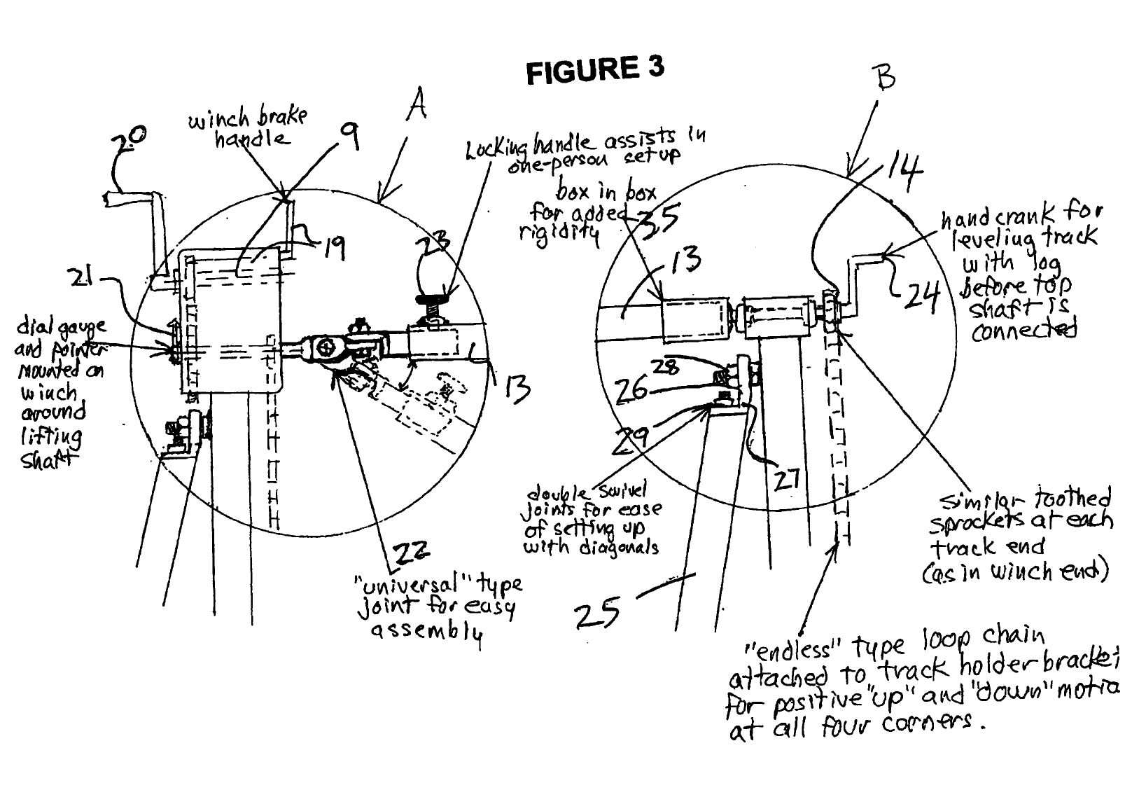

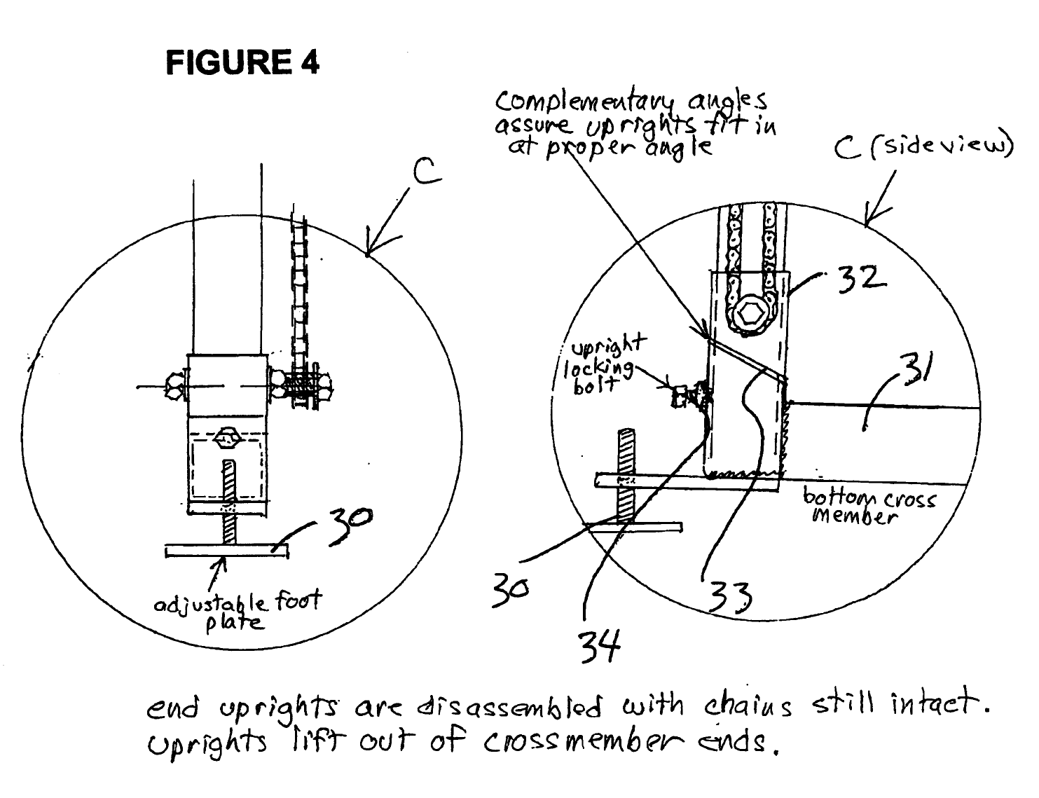

With reference to FIG. 2, the parts encircled and labelled“A” and“B” are detailed in FIG. 3, and the part encircled and labelled“C” is detailed in FIG. 4. Turning to FIG. 3, it can be seen that the winch 9 has a locking brake and handle 19 adjacent the main handle 20. The locking brake and handle 19 is used to lock and thus prevent operation or movement of the winch 9 when appropriate. Associated with the winch 9 is a dial gauge and pointer 21 used for measuring or calibrating the degree of vertical adjustment appropriate for the rails 3 and 4.

With further reference to FIG. 3, assembly of the sawmill is facilitated by the use of a universal type joint 22 between the winch 9 and the shaft 13. In some embodiments of the invention the joint 22 may be considered to be part of the winch 9 or alternatively part of the shaft 13. A locking device 23 may also be utilised to facilitate easy connection of the winch 9 with the shaft 13. As also shown in FIG. 3, a hand crank 24 can be fitted to the sprocket arrangement 14 to enable an operator to level the first rail 3 with respect to the log before the shaft 13 is fitted in place.

FIGS. 1, 2 and 3 show lockable diagonal telescoping ground engaging struts 25 for enhancing the rigidity of the sawmill when operating. As demonstrated in FIG. 3, the ground engaging struts may be linked to the support frames 1 and 2 by way of double swivel joints 26. These double swivel joints 26 include an “L” shaped connection plate 27 bolted to a support frame as shown at 28. By loosening the bolt/nut at 28 the strut may be swung to assume a greater or lessor angle as it proceeds to ground level. The double swivel joints 26 also involve the main longitudinal part of the struts being bolted to the connection plate 27 as shown at 29. By loosening the bolt/nut at 29 the strut may be rotated about that bolt as desired.

Referring to FIG. 4, the base parts of the support frames 1 and 2 may each have an adjustable foot 30 to assist in levelling the sawmill with respect to a ground surface. FIG. 4 also shows that lower cross members 31 forming part of the support frames 1 and 2 may be fitted to uprights 32 which also form part of the end frames. The cross members 31 and the uprights 32 may have complimentary angle abutments as shown at 33 to ensure that the uprights are at the proper angle with respect to the cross members. The uprights 32 and the cross members 31 may be held together by way of locking bolts 34.

In some embodiments of the invention a further support frame or support frames may be utilised between the first and second support frames 1 and 2 so as to sure up the sawmill when the support frames 1 and 2 are spaced a long distance apart—ie for milling long logs. Such further support frames incorporate or are associated with further sleeve containing brackets on which the rails are mounted, and may also be associated with further diagonal struts.

In a further embodiment of the invention opposite uprights of one end support frame are joined by a spinning shaft which can facilitate a vertically directed rails moving force at both sides of that support frame. In this embodiment the moving force can be transferred to opposite ends of the rails by way of a filamentary material extending in a single line or looped arrangement. This may be facilitated by way of a right angle gear box. Optionally a telescopic or rigid shaft can be used in place of such filamentary material. Optionally the spinning shaft mentioned in this paragraph can be replaced by suitable filamentary material connected with a pulley/chain sprocket located near the two winches used for raising and lowering the rails, or near where the uprights are connected.

In further embodiments of the invention the sawmill may be adapted so that the rails 3 and 4 can be raised or lowered in unison by winding only one winch. This can be achieved by way of a suitable cross piece between the winches. In some cases one of the winches may be replaced by a suitable connection means for receiving the cross piece, for example a right angle gear box arrangement. In some embodiments a rigid upper shaft may be connected to the winches such that movement of one winch causes movement of the other.

In some embodiments of the invention the shaft 13 may have at least one end part which, in transverse cross-section, is square or box-like, and fits into a complementary square or box-like recess forming part of or associated with the sprocket arrangement 14. This is shown at FIG. 3 by way of reference numeral 35. The arrangement facilitates a fast and rigid connection between the shaft 13 and the sprocket arrangement 14. The use of the square or box-like arrangement may be particularly useful in the context of telescoping the shaft 13 during assembly of the sawmill. The shaft 13 is may be arranged such that it can telescope outwards to assume a length substantially twice as long as that when the shaft 13 is telescoped fully inwards.

The support frames 1 and 2 may, in some embodiments of the invention, each comprise uprights spaced from one another without bridging reinforcing.

While some preferred aspects and embodiments of the invention have been described by way of example, it should be appreciated that modifications and improvements can occur without departing from the scope of the appended claims.

1. A sawmill, the sawmill having first and second support frame, first and second rails, a first carriage, a second carriage, height adjustment drive means, and connection means;
the sawmill being formed such that when it is in use it can be arranged with the first and second support frames holding the first and second rails in substantially horizontal elevated parallel relationship, the first carriage being associated with the rails and being capable of carrying a saw longitudinally along such rails, the second carriage being capable of moving the saw cross-ways with respect to the rails, the drive means being associated with the first support frame and the connection means connecting the drive means with the first rail and the second end frame;
the sawmill being formed such that when it is in use the drive means can move the connection means to impart a lifting force at each of two opposite end parts of the first rail to cause the first rail to raise while the first rail maintains a substantially horizontal orientation.

2. A sawmill according to claim 1, wherein the connection means comprises filamentary material, a threaded rod or rods, a rotatable shaft or shafts, or a right angle gear box or gear boxes, or suitable combinations of these.

3. A sawmill according to claim 1, wherein the drive means comprises a winch mechanism mounted at one side part of the first support frame.

4. A sawmill according to claim 1, wherein the connection means incorporates filamentary material extending between the drive means and the first rail, incorporates shaft means extending between the support frames, incorporates force transfer means at the second end frame, and incorporates a further filamentary material extending from the force transfer means to the first rail.

5. A sawmill according to claim 1, wherein the connection means comprises a length or lengths of at least one of chain and cord.

6. A sawmill according to claim 1, wherein the connection means incorporates a hollow shaft means.

7. A sawmill according to claim 1, wherein the connection means incorporates a shaft means which is capable of spinning to transfer a degree of force to one of the said two opposite end parts of the first rail which is adjacent the second frame.

8. A sawmill according to claim 1, wherein the connection means incorporates a shaft means, and wherein the shaft means comprises a shaft which is not capable of spinning but houses filamentary material which can move to transfer a degree of force to one of the said two opposite end parts of the first rail wherein that end part is adjacent the second frame.

9. A sawmill according to claim 1, wherein the support frames are associated with diagonal ground engaging telescoping struts to enhance the structural integrity of the sawmill when it is in use.

10. A sawmill according to claim 1, wherein the first and second rails are mounted on sleeve containing brackets, the sleeve containing brackets being capable of moving in a substantially vertical direction along parts of the support frames to move the rails correspondingly.

11. A sawmill according to claim 1, wherein the first and second rails are mounted on sleeve containing brackets, the sleeve containing brackets being capable of moving in a substantially vertical direction along parts of the support frames to move the rails correspondingly, and wherein the sleeve containing brackets are formed such that they can slide along respective rails to enable them to be positioned appropriately with respect to the rails during assembly of the sawmill.

12. A sawmill, the sawmill having first and second support frame, first and second rails, a first carriage, a second carriage, height adjustment drive means, and connection means;
the sawmill being formed such that when it is in use it can be arranged with the first and second support frames holding the first and second rails in substantially horizontal elevated parallel relationship, the first carriage being associated with the rails and being capable of carrying a saw longitudinally along such rails, the second carriage being capable of moving the saw cross-ways with respect to the rails, the drive means being associated with the first support frame and the connection means connecting the drive means with the first rail and the second end frame;
the sawmill being formed such that when it is in use the drive means can move the connection means to impart a lifting force at each of two opposite end parts of the first rail to cause the first rail to raise while the first rail maintains a substantially horizontal orientation;
the sawmill further being formed such that when it is in use the drive means can cause the first and second rails to move in unison while remaining substantially horizontal.
